(19) United States
(12) Patent Application Publication
(10) Pub. No.: US 2002/0089173 A1
(43) Pub. Date: Jul. 11, 2002

(54) Permanent pipe identification tag system and method of using the same

(76) Inventor: Frank Reidy, West Seneca, NY (US)

Correspondence Address: JAECKLE FLEISCHMANN & MUGEL, LLP, 39 State Street, Rochester, NY, 14614-1310, US

(21) Appl. No.: 10/017,810

(22) Filed: Oct. 30, 2001

Related U.S. Application Data
(60) Provisional application No. 60/245,450, filed on Nov. 3, 2000.

(51) Int. Cl. B42D 15/00; G09C 3/00

(52) U.S. Cl. 283/74; 283/81

(57) ABSTRACT

A pipe or other conduit identification labeling system comprising a kit having at least one identification tag for identifying an individual pipe or conduit, a pipe cleaner, and an adhesive bonding agent for adhering the identification tag to the pipe. The kit also includes appropriate directions on how the identification tag can be properly adhered to a pipe or other conduit. The identification tag comprises a one-piece rigid substrate body having raised indicia for identifying an individual pipe located on an upper flat surface, and arcuately shaped lower surface for permitting the lower surface of the identification tag to matingly attach to the corresponding outer surface of the pipe or other conduit by the application of the adhesive bonding agent applied to the lower surface prior to placement of the identification on the pipe. The identification tag can be used to label a variety of pipes and conduits, particularly 1½″ and 2″ PVC pipes used in the plumbing systems of swimming pools and spa.

### CROSS-REFERENCE TO RELATED-APPLICATIONS

This applications claims the benefit of U.S. Provisional Patent Application Serial No. 60/245,450, filed Nov. 3, 2000 (Attorney Docket No. 89751.155200).

### FIELD OF THE INVENTION

The present invention pertains to an identification system, and more particularly, to a pipe identification system for identifying individual pipes, wherein identification tags having raised identifying indicia are permanently bonded to a pipe, as well as kits containing and methods of using the same.

### BACKGROUND OF THE INVENTION

Presently, various methods of marking pipes and other conduits with identifying features are used, but all have their drawbacks, and are usually directed to large scale industrial settings, particularly in the area of hazardous and flammable chemicals and the like. One method of marking pipes has been to hand paint, draw and/or stencil the pipe with flow direction and substance transported in the pipe. This method has various drawbacks such as extremely time consuming, expensive, particularly due to the time, paints, markers, rollers, etc; required, the legible life of the markings are typically low due to fading, chipping, smudging and other types of deterioration.

Another method used for marking pipes has been to apply colored adhesive tape around a pipe. The adhesive tape may also have thereon written identification information pertaining to the pipe the tape is attached to. As well as some of the above disadvantages this method has the disadvantage that due to peeling to peeling and smudging of identification written on the tape, the life expectancy of such marking is short.

Other modes of removably identifying pipes are as follows.

U.S. Pat. No. 4,246,712 to Vander Wall discloses a pipe identification system including a removable multi-piece marker fabricated from a rigid material and having indicia imprinted thereon for providing information on the pipe contents and flow direction of the pipes. The flow direction markers are removably secured and integral with the opposite ends of the contents marker. Each flow direction marker has indicia thereon indicating flow direction. One or both of the flow direction markers may be separated from the contents marker prior top attachment of the marker to the pipe. One or more straps engage the markers for attaching the markers to a pipe. Vander Wall fails to teach a one piece permanently attached pipe identification tag having raised indicia.

U.S. Pat. No. 5,138,784 to Niwa discloses a pipe identification system using removable marking collars which indicate the contents of a pipe and/or the direction of fluid flow. The pipe contents may be indicated by the color of the marking collar or by symbols marked on the collar.

Niwa fails to teach a one piece permanently attached pipe identification tag having raised indicia.

A system for permanently labeling pipes and other such conduits, like those used in the plumbing systems of swimming pools and spas typically found in homes, health clubs, hotels and resorts, that is convenient and relatively inexpensive for the consumer, homeowner, installer and/or repairmen to use. Additionally, the identification tags should be reliable, long lasting, resistant to smudging, fading and other agents of deterioration typically encountered during the normal course of handling and weathering either above ground, below ground or under water.

When pipes used in the plumbing systems for swimming pools and spas are unlabeled, or become unlabeled, even the seasoned professional installer or repairman typically has great difficulty in determining the identity of an individual pipe thereby leading to increased errors and/or a increased labor costs associated with the time wasted in trying to determine the proper identity of a particular unlabeled pipe.

The current invention is directed towards addressing these needs by providing a system that includes identification tags kits for identifying individual pipes, and method of using the same for permanently labeling pipes used the plumbing of swimming pools and spas by permanently adhering identification tags to the outer walls of individual pipes.

### SUMMARY OF THE INVENTION

It is an object of the present invention to provide a pipe identification system for identifying individual pipes wherein identification tags having raised identifying indicia thereon are permanently bonded to a corresponding pipe, as well as kits containing the same, and methods of permanently applying the identification tags via an adhesive bonding agent to the outer wall of a pipe or other such similar conduit.

Further objects will become apparent from the following written description and drawings.

### BRIEF DESCRIPTION OF THE DRAWINGS

FIG. 1 depicts a pipe labeled with an identification tag according to one embodiment of the present invention;

FIG. 2 depicts an exploded view of the labeled pipe and the identification tag shown in FIG. 1;

FIG. 3 depicts a top plan view of the identification tag according to one embodiment of the present invention;

FIG. 4 depicts a side view of the identification tag according to one embodiment of the present invention;

FIG. 5 depicts a cross sectional view of the identification tag and two pipes labeled by the tag shown in phantom and having different diameters according to one embodiment of the present invention;

FIG. 6 depicts the lower side of the identification tag (that side which comes in contact with the outer wall of the pipe) according to one embodiment of the present invention;

FIG. 7 depicts a schematic plumbing diagram for a swimming pool and health spa.

### DETAILED DESCRIPTION OF THE PREFERRED EMBODIMENT

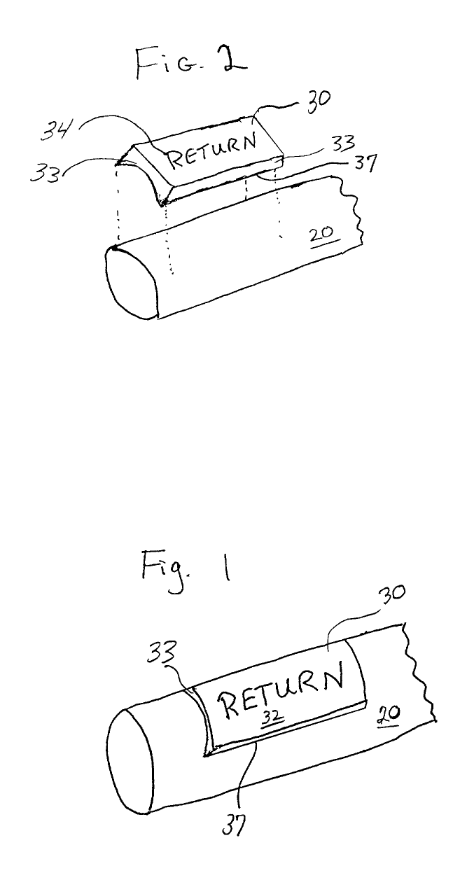

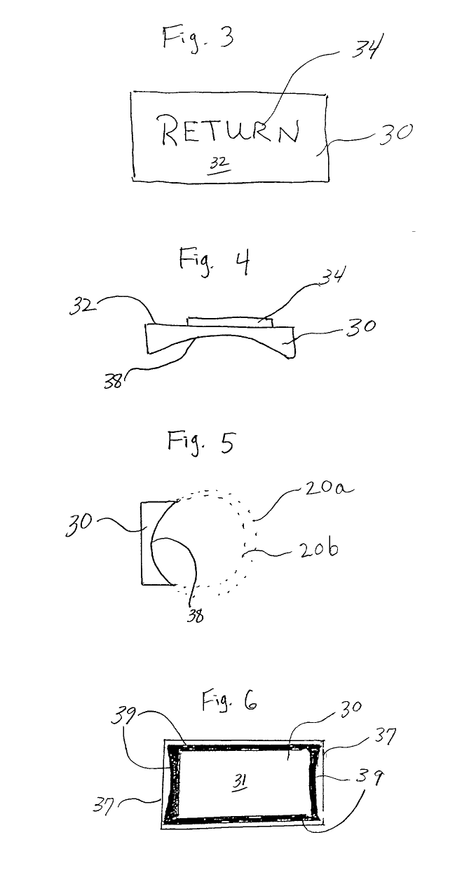

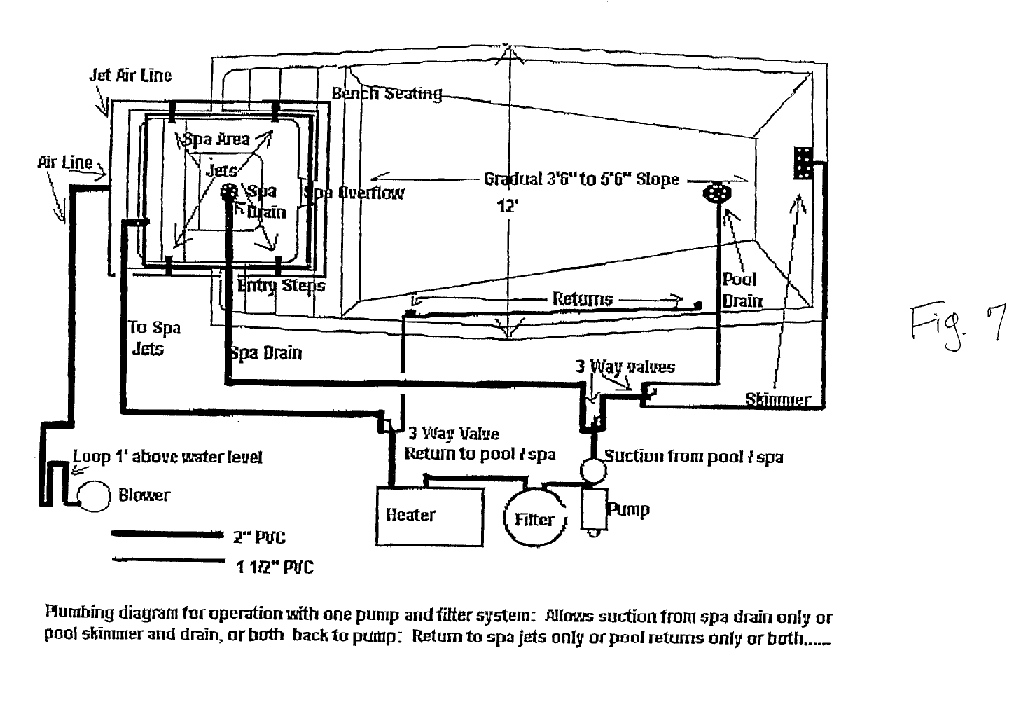

As seen FIGS. 1-7, the identification tag 30 comprises a one-piece rigid substrate body having an outer wall 33 of varying height around the entire side perimeter of tag 30, raised indicia 34 for identifying an individual pipe (20, 20a, 20b) located on an upper flat surface 32, an arcuately shaped lower region 38 on two opposing sides of wall 33, and a lower edge 37, located on the bottom side 31, to matingly attach (best seen in FIGS. 2 and 5) to the corresponding outer surface of a pipe (20, 20a, 20b) or other conduit, by the application of an adhesive bonding agent applied to the lower edge 37, prior to placement of the identification tag 30 on the pipe (20, 20a, 20b). The identification tag 30 can be used to label a variety of pipes and conduits, particularly 1½″ 20a and 2″ 20b PVC pipes, used in the plumbing systems of swimming pools and spa.

The term “permanently” as used herein is means that the identification tag is to remain affixed to an individual pipe for the lifetime of the pipe and is not meant to be removable. Because the identification is affixed by an adhesive bonding agent, it should not come off the pipe during the normal course of weathering and natural deterioration either above ground, below ground or below water.

FIG. 6 depicts the bottom side view 31 of the identification tag 30 having inner wall 39 located around the entire perimeter of the tag 30 and the lower edge 37 also around the bottom perimeter of the tag 30. Lower edge 37 is that portion of tag 30 that actually contacts the outer perimeter of the pipe 20.

A schematic plumbing diagram for a typical swimming pool and health spa wherein the identification tags of the current invention can be used is depicted in FIG. 7.

In a preferred embodiment, the pipe identification system kit includes identification tags made from molded PVC for labeling PVC plumbing pipes used in swimming pools and/or health spas including, but not limited to, tags having the following raised indicia labeled thereon: “SUCTION”, “RETURN” (two tags); “MAIN”, “SKIMMER”, “POOL CLEANER”, “JETS” (two tags), “AIR BLOWER”, “WASTE LINE”, “ARROWS” (two tags), “SPA”; “ON”, “OFF”, and “WATER FALLS”. The kit also preferably includes a PVC adhesive, a PVC pipe cleaning agent, and directions for proper use on adhering the tags to the outer surface of pipe.

In an alternative embodiment, the tags can be multi-colored to allow for enhanced visibility of the raised indicia or for color coding purposes. For example, the body of the tag could be white, while the raised indicia is red, thereby rendering the red raised indicia easier to read against the white background of the tag body.

While the preferred material for the identification tags consists of PVC, many other polymeric materials can be used including, but not limited polyethylene, polypropylene, CPVC, polyacrylics to name a few. Preferably the identification tag is molded from one piece of plastic.

While the preferred bonding agent is PVC cement, other adhesives that promote proper bonding between the material used to make the tags and the material used to make pipe can be used.

A preferred method of using the pipe identification kit in accordance with the present inventions is as follows:

The kit includes: PVC identification tags, a known PVC pipe cleaning agent used in the industry and a PVC cement also know and used in the industry,

1. Clean PVC pipe with a PVC pipe cleaner. This will not only clean the pipe, but it will also soften the pipe to allow for better adhesion.

2. Apply a PVC cement to the back of the identification tag.

3. Apply the tag with the PVC cement located thereon to the cleaned area, applying pressure to the tag for about 30 seconds to ensure proper adhesion.

While the invention has been described with reference to preferred embodiments, it will be understood by those skilled in the art that various changes may be made and equivalents may be substituted for elements thereof without departing from the scope of the invention. In addition, many modifications may be made to adapt a particular situation of material to the teachings of the invention without departing from the scope of the invention. Therefore, it is intended that the invention not be limited to the particular embodiments disclosed as the best mode contemplated for carrying out this invention, but that the invention will include all embodiments falling within the scope and spirit -of the appended claims.

What is claimed:

1. An identification label kit for pipes comprising an identification tag having a one-piece rigid substrate body having an outer wall of varying height around the entire side perimeter of said tag, raised indicia for identifying said pipe located on an upper flat surface, an arcuately shaped lower region on two opposing walls, and a lower edge located on the bottom of said tag for matingly attaching said tag to the corresponding outer surface of a pipe, by the application of an adhesive bonding agent applied to said lower edge, prior to placement of said identification tag on the pipe; and
an adhesive.

2. The kit according to claim 1, wherein said identification tag comprises PVC.

3. The kit according to claim 1, wherein said adhesive comprises PVC cement.

4. The kit according to claim 1, further comprising a PVC pipe cleaning agent.
